(19) United States
(12) Patent Application Publication
(10) Pub. No.: US 2016/0174763 A1
(43) Pub. Date: Jun. 23, 2016

(54) CONTAINER HOLDER AND METHOD OF USING SAME

(71) Applicant: BRADSHAW INTERNATIONAL, INC., Rancho Cucamonga, CA (US)

(72) Inventor: Christopher W. GLUPKER, Rancho Cucamonga, CA (US)

(73) Assignee: BRADSHAW INTERNATIONAL, INC., Rancho Cucamonga, CA (US)

(21) Appl. No.: 14/575,145

(22) Filed: Dec. 18, 2014

(51) Int. Cl. A47J 36/34; A23L 1/182; A47J 47/02; A23L 1/162; A47J 27/00; A47J 36/14

(52) U.S. Cl. CPC A47J 36/34; A47J 27/002; A47J 36/14; A47J 47/02; A23L 1/162; A23L 1/182; A47J 2027/006; A47J 2203/00; A23V 2002/00

(57) ABSTRACT

A container holder and a method of using the container holder to prepare a food product are provided. The container holder includes a body having an outer wall and an inner wall joined to the outer wall at an upper portion of the body, the inner wall defining a space, a spout formed at the upper portion of the body and a handle provided opposite the spout on the body. The food product is provided in a container having a removable lid. The method includes adding liquid to the space in the container holder, heating the liquid in the container holder by using a microwave, removing the lid from the container, pouring the liquid from the container holder into the container and placing the container in the space of the container holder.

### CROSS-REFERENCE TO RELATED APPLICATION

This application is related to U.S. application Ser. No. 29/489,803, filed May 2, 2004, and is herein expressly incorporated by reference in its entirety.

### BACKGROUND OF THE INVENTION

1. Field of the Invention

The present invention is directed generally to a container holder and method of using the container holder and, more particularly, to container holder for holding a prepackaged food product and a method of using the container in preparing food from the prepackaged food product.

2. Description of Related Art

Some types of prepackaged food products include dehydrated or other dry food that is prepackaged in a container with a removable lid. The lid may be a thin, flexible membrane or a more rigid structure. The dehydrated or dry food is intended to be combined with water or other liquid to provide a consumable food product. For example, the consumable food product may be instant noodles or instant rice. In order to make instant noodles, a user removes the lid and adds hot water to the container so that the instant noodles are submerged in the water. The water may be first heated to a boil and subsequently poured into the container or the water may be first poured into the container with the instant noodles and the container is subsequently placed into a microwave to be heated. If the water is heated before being added to the container, the consumer lets the mixture stand for several minutes before the food products can be consumed.

Because these types of food products generally require that the water reach a boil to properly heat the dehydrated or dry food stuffs, there is a chance that a consumer may accidentally burn themselves if the prepackaged container gets too hot.

### BRIEF SUMMARY OF THE INVENTION

According to principles of this invention it is possible to provide a container holder that lessens the chance of a user burning themselves by contact with the container holder.

According to additional principles of this invention it is possible to provide a single container holder that both holds water or other liquids that are to be heated or brought to a boil in a microwave and subsequently holds the container for the food products while the food products are consumed.

According to one aspect of the present invention, a container holder is provided. The container holder includes a body having an outer wall and an inner wall joined to the outer wall at an upper portion of the body, the inner wall defining a space configured to receive a food container, a spout formed at the upper portion of the body, a handle provided opposite the spout on the body and a removable cover, the removable cover being detachable from an outer surface of the inner wall.

According to another aspect of the present invention, a method of using a container holder to prepare a food product is provided. The container holder includes a body having an outer wall and an inner wall joined to the outer wall at an upper portion of the body, the inner wall defining a space, a spout formed at the upper portion of the body and a handle provided opposite the spout on the body. The food product is provided in a container having a removable lid. The method includes adding liquid to the space in the container holder, heating the liquid in the container holder by using a microwave, removing the lid from the container, pouring the liquid from the container holder into the container and placing the container in the space of the container holder.

According to yet another aspect of the present invention, a kit is provided. The kit includes a container holder and a prepackaged food product. The container holder includes a body having an outer wall and an inner wall joined to the outer wall at an upper portion of the body, the inner wall defining a space configured to receive a food container, a spout formed at the upper portion of the body, a handle provided opposite the spout on the body and a removable cover, the removable cover being detachable from an outer surface of the inner wall. The prepackaged food product includes a container, a lid and a dehydrated or dry food located in the container. The container is sized to fit in the space of the container holder.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a perspective view of a container holder and a prepackaged food product;

FIG. 2 is a sectional view of the container holder of FIG. 1;

FIG. 3 illustrates using the container holder of FIG. 1 to add water to the food product;

FIG. 4 illustrates using the container holder of FIG. 1 to hold a container after adding water to the container; and

FIG. 5 illustrates an optional step of using a cover of the container holder of FIG. 1.

### DETAILED DESCRIPTION OF THE INVENTION

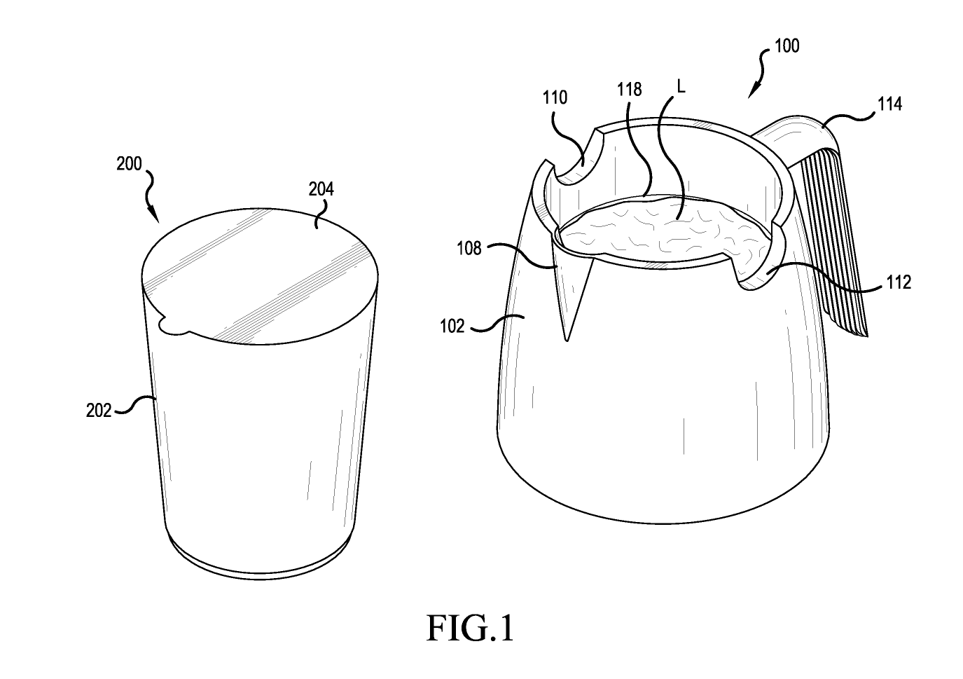

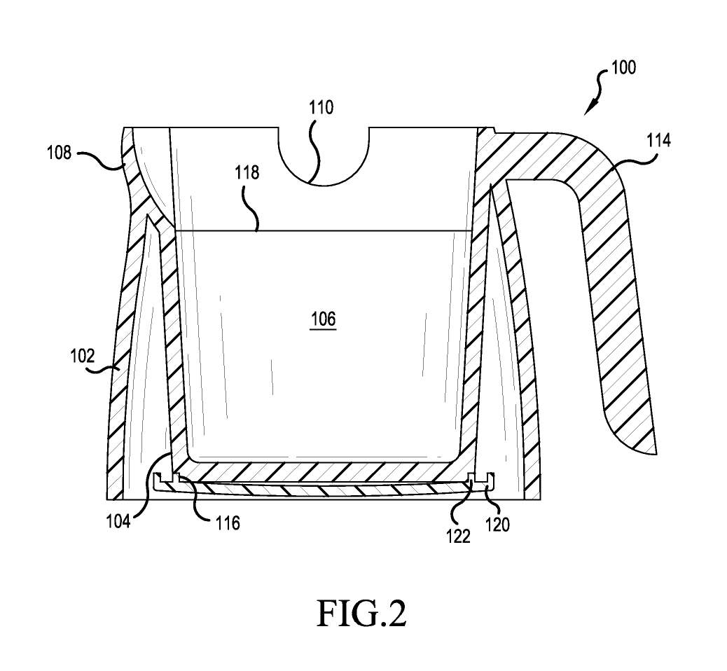

As shown in FIGS. 1 and 2, the container holder 100 includes an outer wall 102 and an inner wall 104 joined at an upper portion of the container holder 100. The inner wall 104 defines a space 106 to receive a prepackaged food product 200 or liquid L therein. The upper portion of the container holder 100 may include a spout 108 and two recessed portions 110, 112. A handle 114 may be provided opposite the spout 108. According to this exemplary embodiment, the container holder 100 may be a one piece construction with a wider bottom than a top thereby providing a lower center of gravity to resist tipping of the container holder 100.

A detachable cover 120 may be provided as a part of the container holder 100. As shown in FIG. 2, the cover 120 may include a rib portion 122 that cooperates with a lower portion or bottom of the inner wall 104. Depending on the respective size of the rib portion 122 and the lower portion of the inner wall 104, the lower portion of the inner wall 104 may be provided with a seat 116 to which the rib portion 122 is mountable.

The space 106 may be gradually tapered from the top of the container holder 100 to the bottom of the inner wall 104 to receive different sized prepackaged food products therein. In addition, an inner surface of the inner wall may include a liquid-fill line 118 to represent a predetermined volume within space 106. It is understood that additional liquid-fill lines may be provided to represent different volumes within space 106.

The container holder 100 may be formed of plastic or other suitable material so that liquid L provided in space 106 may be heated to a boil without damaging the container holder 100. Because the container holder 100 includes an outer wall 102 and an inner wall 104, it is possible for the outer wall 102 to remain cool to the touch so as to avoid burning the skin of a user that comes into contact with the outer wall 102.

As shown in FIG. 1, the prepackaged food product 200 includes a container 202 and a removable lid 204. The dehydrated or dry food, such as instant noodles, is located in the container 202. It is understood that the prepackaged food product 200 may come in various sizes and the size of the space 106 of the container holder 100 may be selected to accommodate various sized containers.

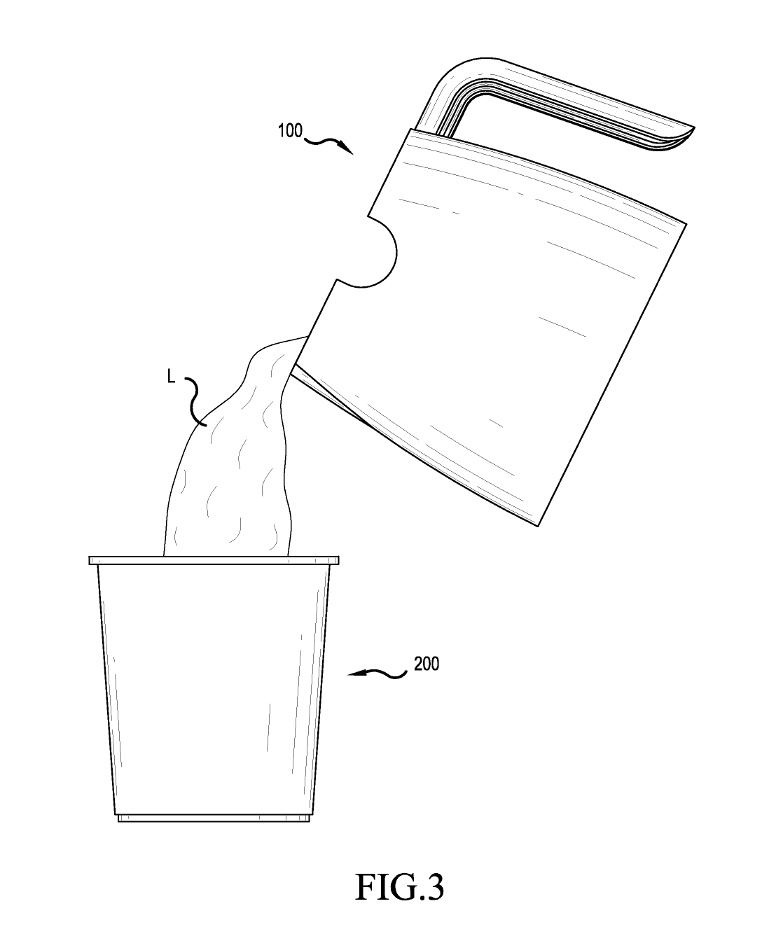

Having described the container holder 100, a method of using the container holder to prepare the prepackaged food product 200 is illustrated in FIGS. 3-5. While a particular order is set forth below it is understood that the order of steps may be varied.

First, the container holder 100 is filled with liquid L, which may be water, to the liquid-fill line. Then, the container holder 100 is placed in a microwave, which is then operated to heat the liquid L in the container holder 100. The liquid may be heated to a boil. As shown in FIG. 3, once the liquid L in the container holder 100 is heated, the liquid L is poured into the container 202 after the lid 204 has been removed from the container 200, so that the dehydrated or dry food is submerged or surrounded by the liquid L.

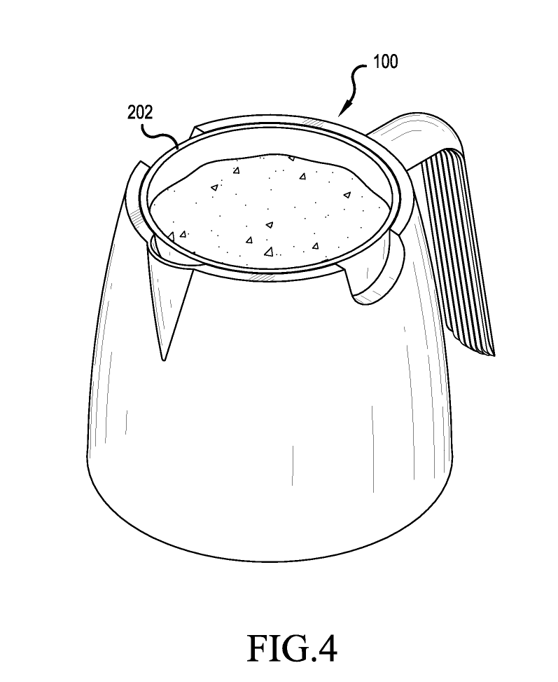

Next, as seen in FIG. 4, the container body 202 may be placed in the container holder 100 while the dehydrated food steeps or cooks for a time specific to the preparation of the dehydrated or dry food. The user adds/removes the container 202 to/from space 106 by using the recessed portions 110, 112 in the container holder 100 so that the user's fingers do not come into contact with the container body 202. Depending on the size of the container 202, the container 202 may be suspended in space 106 via contact with the inner wall 104 or be supported by the bottom of the inner wall 104. While FIG. 4 shows the upper portion of the container 202 as being at the same level as the upper portion of the container holder 100, it is understood that the upper portion of the container 202 may be above or below the upper portion of the container holder 100.

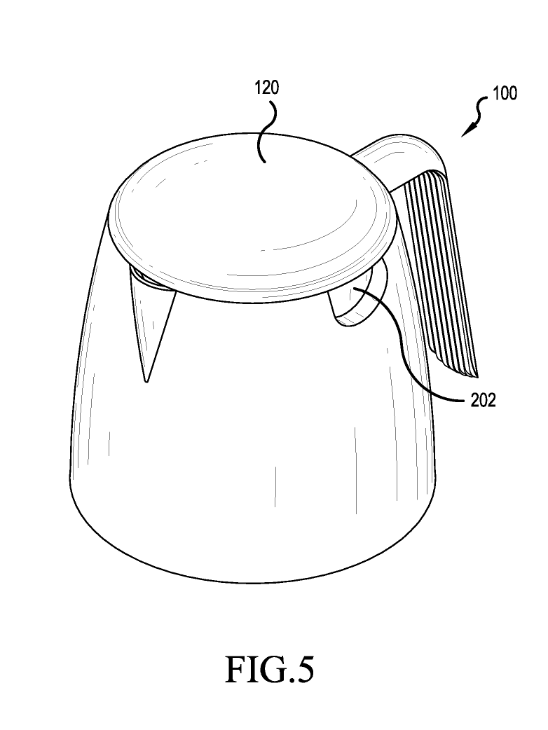

Optionally, as seen in FIG. 5, the cover 120 may be placed on the container 202, either before or after placing the container 202 into space 106. Depending on the size of the container 202, the upper portion of the container 202 may fit between the rib portion 122 and the outer perimeter of the cover 120. The cover 120 may assist in retaining heat in the container 202. After the specific time required to heat or cook the dehydrated or dry food, the cover 120 may be removed.

After heating or cooking the dehydrated or dry food, the user can leave the container 202 in the container holder 100 while consuming the food or remove the container 202 from the container holder 100 if so desired.

While one method of using the container holder 100 has been described above, it is understood that the container holder 100 could be used in other ways. For example, the user may empty the dehydrated or dry food from the prepackaged food product 200 into the container holder 100, add liquid to the container holder 100 and then microwave the container holder 100 to heat the liquid and the dehydrated or dry food at the same time.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of using a container holder to prepare a food product, the container holder having a body having an outer wall and an inner wall joined to the outer wall at an upper portion of the body, the inner wall defining a space, a spout formed at the upper portion of the body and a handle provided opposite the spout on the body, the food product being provided in a container having a removable lid, the method comprising:
adding liquid to the space in the container holder;
heating the liquid in the container holder by using a microwave;
removing the lid from the container;
pouring the liquid from the container holder into the container; and
placing the container in the space of the container holder.

2. The method of claim 1, wherein the food product is a dehydrated or dry food, and wherein the method includes allowing the dehydrated or dry food to cook before consuming.

3. The method of claim 3, wherein the food product is instant noodles or instant rice.

4. The method co claim 1, wherein the container comprises a pair of recesses formed at the upper portion of the body such that the container is graspable to allow placement or removal of the container from the container holder without contacting the body.

5. The method according to claim 1, wherein the inner wall is configured such that the space tapers from the upper portion of the body towards a lower portion of the body, and
wherein placing the container in the space of the container holder includes supporting the container by contact with the inner wall.

6. The method according to claim 1, wherein the container holder includes a removable cover, the removable cover being detachable from an outer surface of the inner wall, and
wherein the method further comprises:
detaching the cover from the inner wall; and
placing the cover on the container after pouring the liquid from the container holder into the container or after placing the container in the space of the holder.

7. The method according to claim 6, wherein the removable cover includes a rib portion spaced inward from an outer perimeter of the removable cover, and
wherein placing the cover on the container includes arranging an upper portion of the container to be located between the rib portion and the outer perimeter of the removable cover.

8. The method according to claim 7, wherein the inner wall includes a seat to which the rib portion is mountable/detachable.

9. The method according to claim 6, further comprising:
removing the cover from the container; and
mounting the cover on the inner wall.

10. The method according to claim 1, wherein the inner wall includes indicia of a liquid-fill line, and
wherein adding liquid to the space includes filling the space up to the liquid-fill line.

11. A container holder comprising:
a body having an outer wall and an inner wall joined to the outer wall at an upper portion of the body, the inner wall defining a space configured to receive a food container;
a spout formed at the upper portion of the body;
a handle provided opposite the spout on the body; and
a removable cover, the removable cover being detachable from an outer surface of the inner wall.

12. The container according to claim 11, further comprising a pair of recesses formed at the upper portion of the body.

13. The container according to claim 11, wherein the inner wall is configured such that the space tapers from the upper portion of the body towards a lower portion of the body.

14. The container according to claim 13, wherein the removable cover includes a rib portion spaced inward from an outer perimeter of the removable cover.

15. The container according to claim 14, wherein the inner wall includes a seat to which the rib portion is mountable.

16. The container according to claim 11, wherein the outer wall and inner wall diverge from the upper portion.

17. The container according to claim 11, wherein the inner wall includes indicia of a liquid-fill line.

18. A kit comprising:
a container holder, the container holder having:
a body having an outer wall and an inner wall joined to the outer wall at an upper portion of the body, the inner wall defining a space configured to receive a food container;
a spout formed at the upper portion of the body;
a handle provided opposite the spout on the body; and
a removable cover, the removable cover being detachable from an outer surface of the inner wall; and
a prepackaged food product, the prepackaged food product having:
a container;
a lid; and
a dehydrated or dry food located in the container,
wherein the container is sized to fit in the space of the container holder.
